(19) United States
(12) Patent Application Publication
(10) Pub. No.: US 2007/0071950 A1
(43) Pub. Date: Mar. 29, 2007

(54) Composite print and method of manufacturing on a plaque

(75) Inventor: Michael Chaimberg, Montreal (CA)

Correspondence Address: OGILVY RENAULT LLP, 1981 MCGILL COLLEGE AVENUE, SUITE 1600, MONTREAL, QC, H3A2Y3, CA

(73) Assignees: The Chaimberg 5 Holdings Inc.; Gestion Chaimberg 5 Inc.

(21) Appl. No.: 11/232,910

(22) Filed: Sep. 23, 2005

(51) Int. Cl. B44C 1/17

(52) U.S. Cl. 428/195.1

(57) ABSTRACT

A method of manufacturing a decorative plaque from a paper printed image is described. A canvas texture pattern is embossed in a sheet of paper having an image printed on a front face thereof. The embossed sheet is then secured on a backing support member from a rear face of the paper image. A clear UV protective coating is applied over the front face. The image printed on the paper resembles that of a painting made on canvas or an image printed directly on canvas.

### CROSS-REFERENCE TO RELATED APPLICATION

Reference is made to my U.S. Pat. No. 6,920,712 B2 entitled “COMPOSITE LAMINATED PRINT AND FRAME AND METHOD OF FABRICATION”, issued on Jul. 26, 2005, which relates to a laminated product using real canvas material.

### TECHNICAL FIELD

The present invention relates to a composite print on fabric and a method of manufacturing a decorative plaque from a paper printed image which has been embossed with a canvas texture pattern whereby to resemble real canvas.

### BACKGROUND ART

It is known to laminate paper images with clear plastic material. It is further known to glue the laminated image on a solid backing material. In order to resemble an original work of art, it is also known to cover the image sheet with varnish material using brush strokes whereby to impart in the varnish a texture with brush strokes appearing therein to thereby simulate a real painting. Such processes are expensive due to the labour content required for applying the varnish material. It is also known to glue paper prints on plaques.

### SUMMARY OF INVENTION

It is a feature of the present invention to provide a composite print adhere over a fabric material which is secured to a hollow frame and wherein the fabric material resembles canvas or is actual canvas.

It is a feature of the present invention to provide a method of manufacturing a decorative plaque from a paper printed image to resemble an image painted or printed on real canvas material.

Another feature of the present invention is to provide a method of manufacturing a decorative plaque and wherein the paper printed image is embossed with a canvas texture pattern.

Another feature of the present invention is to provide a method of manufacturing a paper printed image having a canvas texture pattern throughout.

Another feature of the present invention is to provide a decorative image plaque having a paper printed image which has a canvas texture pattern embossed therein.

According to the above features, from a broad aspect, the present invention provides a composite print and frame comprising a circumferential hollow frame member having a flat outer contour surface. A sheet of fabric material is disposed taut over the frame and secured over the flat outer contour surface. A printed image sheet has a rear surface thereof adhered over the sheet of fabric material. The image sheet extends to circumferential edges of the frame. The image sheet has an image on a top surface thereof. A protective transparent varnish material is provided on the image sheet for protecting the image. Fastening means is provided for retaining the sheet of fabric material taut.

According to the above features, from a broad aspect, the present invention provides a method of manufacturing a decorative plaque from a paper printed image. The method comprises the steps of embossing a canvas texture pattern in a sheet of paper having an image printed on a front face thereof. A rear face of the sheet is then secured on a backing support member. A clear UV protective coating is then applied over the front face.

According to another broad aspect of the present invention there is provided a decorative image plaque comprising a sheet of paper having an image printed on a front face thereof. The sheet of paper is embossed throughout with a canvas texture pattern. The rear face of the sheet of paper is glued on a rigid flat backing support member. A clear protective coating protects the front face.

According to a further broad aspect of the present invention there is provided a composite print and frame comprising a circumferential hollow frame member having a flat outer contour surface. A sheet of fabric material is disposed taut over the frame and secured to the flat outer contour surface. A printed image sheet has a rear surface thereof adhered over the sheet of fabric material. The image sheet extends to circumferential edges of the frame. The image sheet has an image on a top surface thereof, a protective transparent varnish material on the image sheet for protecting the image and fastening means for retaining the sheet of fabric material taut.

### BRIEF DESCRIPTION OF DRAWINGS

A preferred embodiment of the present invention will now be described with reference to the accompanying drawings in which:

FIG. 1A is a front view of a paper printed image;

FIG. 1B is a front view similar to FIG. 1A but with the paper printed image having been embossed with a canvas texture pattern;

FIG. 1C is a perspective view of the embossed paper printed image secured to a backing support member;

FIG. 2 is a perspective view illustrating the paper printed image being embossed between an engraved roll having a canvas texture pattern and a backing roll;

FIG. 3 is an exploded view showing the embossed paper printed image being applied to a backing support member;

FIG. 4 is a simplified side view showing the laminated paper printed image sheet and backing support member being fed through press rolls;

FIG. 5 shows the laminated paper printed image being sprayed with a UV protective varnish coating;

FIG. 6 shows the laminated paper printed image being heat-treated after being varnished as illustrated in FIG. 5;

FIG. 7 shows the decorative plaque secured within a picture frame;

FIG. 8 is a fragmented section view showing the paper printed image secured to a thick rigid backing member which has been routed a decorative shape about outer edges thereof;

FIG. 9 is a perspective view of a composite print secured to a hollow frame and fabricated in accordance with the present invention;

FIG. 10 is an exploded view illustrating the construction of the print and frame of FIG. 9; and

FIG. 11 is an enlarged section view illustrating the composite print and frame construction.

### DESCRIPTION OF PREFERRED EMBODIMENTS

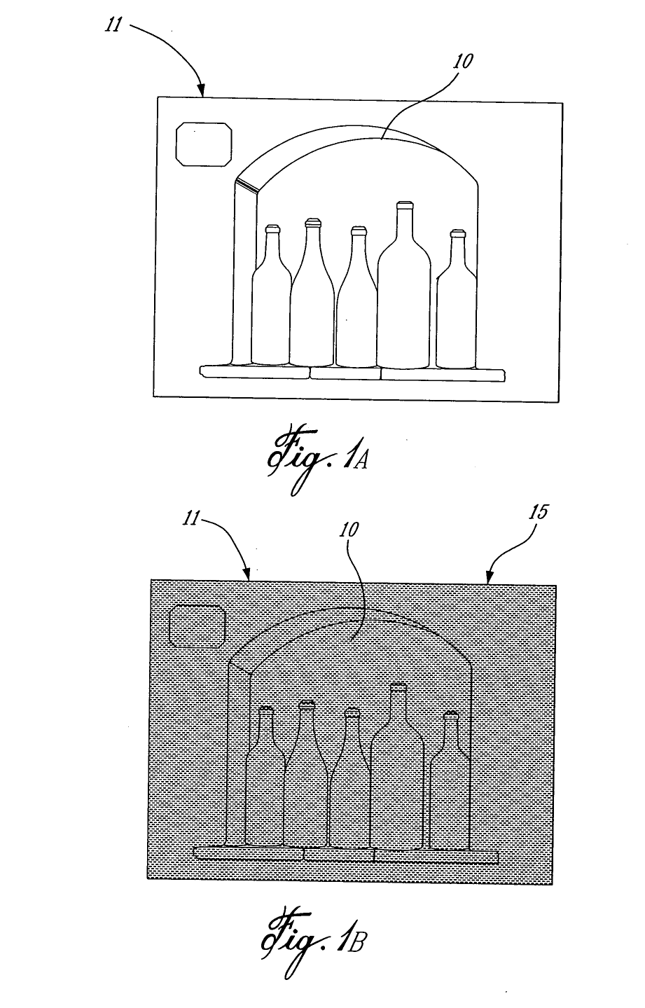

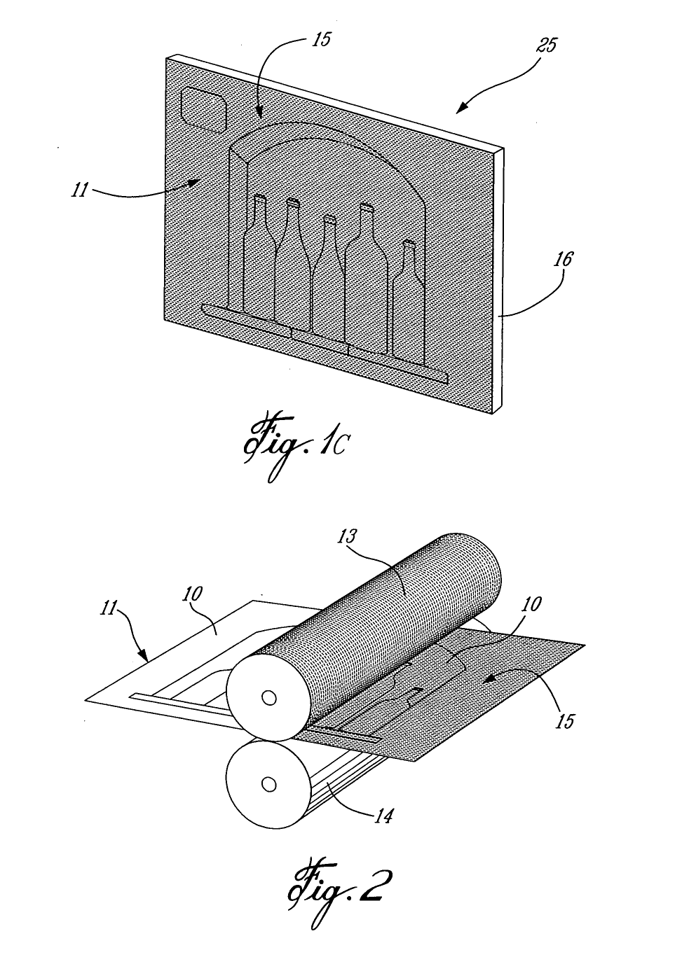

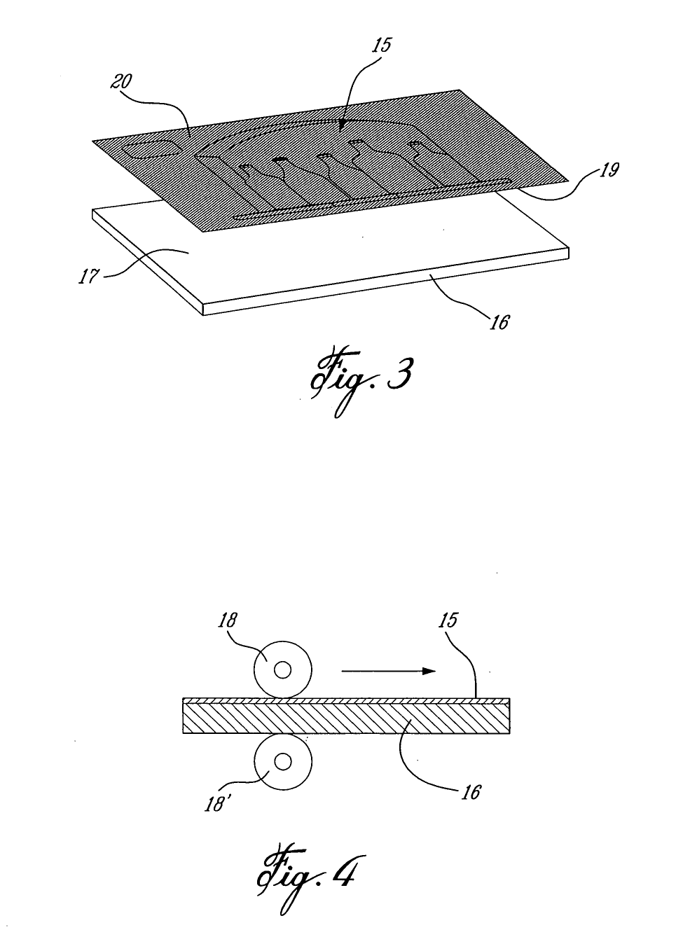

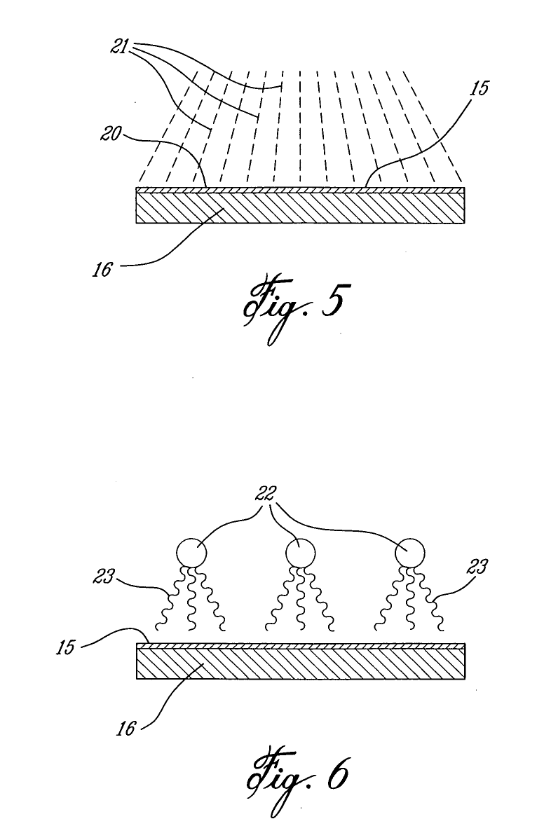

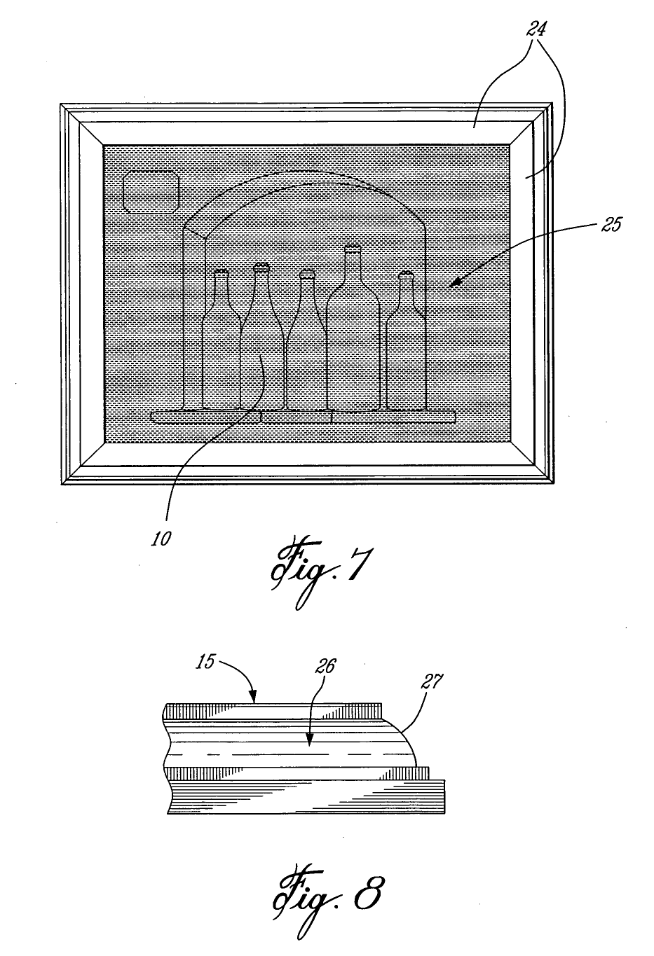

Referring now to the drawings and more particularly to FIGS. 1A to 3, there is shown more specifically at FIG. 1A a paper printed image 10 printed on a paper sheet 11. As shown in FIG. 2, the paper sheet 11 is fed between an engraved roll 12 having a canvas texture engraving 13 therein and a backing roll 14. The rolls 12 and 14 are biased against one another whereby the canvas texture engraving 13 is embossed throughout the paper sheet 11 whereby to produce an embossed paper sheet 15 having a canvas texture pattern embossed therein as illustrated in FIG. 1B. The embossed canvas texture pattern produces bumps and valleys formed in the front face 20 and rear face 19 of the paper sheet 11 whereby to form a texture resembling canvas and wherein the texture can be felt by rubbing ones fingers over the sheet.

The embossed canvas texture sheet 15 is then glued to a backing support member 16 by applying glue 17 therebetween. This forms a laminated rigid decorative plaque which is then fed between press rolls 18 and 18′ as illustrated in FIG. 4 whereby to press the rear face 19 of the paper sheet onto the glue surface 17 of the backing support member 16.

The front face 20 of the embossed paper sheet 15 is then applied a clear protective coating such as a UV varnish 21 thereover. This application can be done by spray nozzles or by rollers or brushes. The varnish is then dried quickly through a tunnel dryer type equipment where heat producing elements 22 radiate heat 23 on the top surface 20 of the paper sheet, as illustrated in FIG. 6. The second coat can then be dried again by passing the laminated paper sheet and backing member through the tunnel dryer.

The backing support member 16 may be comprised of several suitable type materials such as paper board, massonite, MDF, rigid cardboard material, etc.

The laminated embossed paper sheet and backing material can then be disposed within a frame 24 to resemble a real painting mounted in a frame or may simply be displayed in the form of a decorative plaque 25 as shown in FIG. 1C.

As shown in FIG. 8, the backing support member is a thick MDF board 26 wherein a decorative shape 27 has been routed along its outer edges thereof.

Referring now to FIG. 9, there is shown a perspective view of a composite print 31 secured to a circumferential hollow frame 32. The hollow frame 32 has a flat outer contour surface or side edge 33. As shown in FIG. 9, the frame is a rectangular frame and therefore has four flat outer contour surfaces 33.

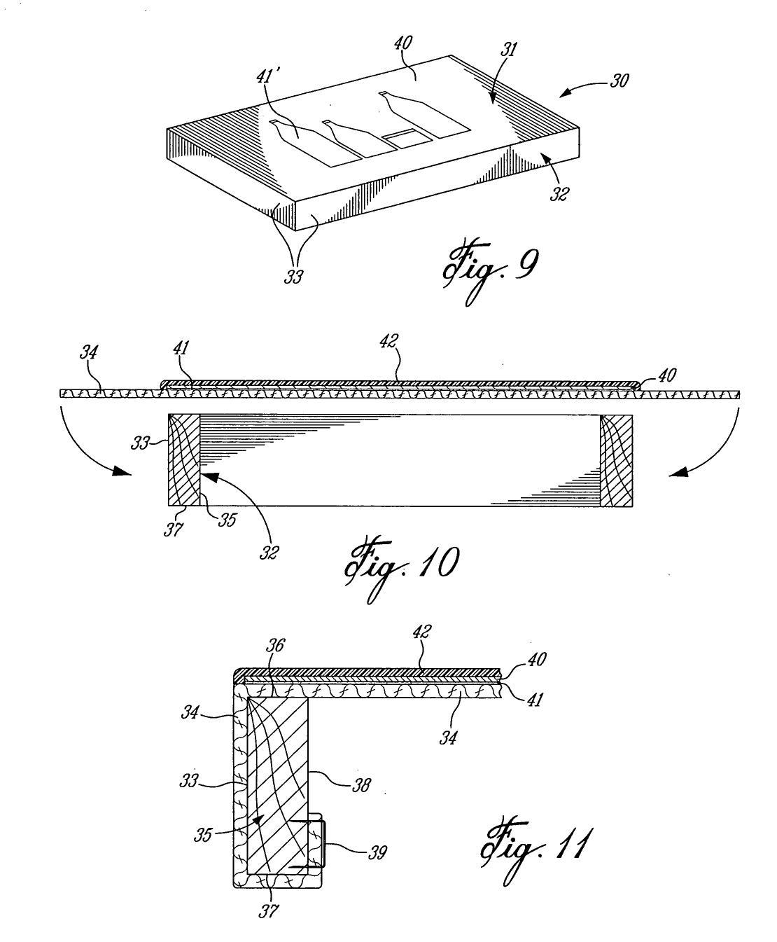

With additional reference to FIGS. 10 and 11, it can be seen that the composite print and frame 30 of the present invention is comprised of a sheet of fabric material 34 which can be canvas, burlap, cheesecloth or other material resembling canvas and such is first secured taut to the frame members 35 in a manner as shown in FIG. 11. The fabric material 34 is disposed taut over the top surfaces 36 of the frame and over the outer contour surfaces 33, about the bottom surface 37 whereat it may be secured by fasteners or as hereinshown can be looped back into the inner surface 38 where it is secured by staple fasteners 39. The hollow frame 32 is open on the rear thereof and wherein the sheet of fabric material is visible giving the impression that the image 41 is painted directly on the fabric material or printed directly thereon. That material is also accessible whereby a potential buyer can feel the material giving the impression that the image is an original on canvas or similar material as above-described.

A printed image paper sheet 40 is coated with glue 41 on a rear surface thereof and is applied over the top surface of the fabric material spanning the frame. This image sheet extends to the circumferential edges 33 of the frame 32. The image sheet has an image 41′ printed thereon. A protective transparent varnish material 42 is then applied over the image sheet for protecting the image printed on the sheet.

The varnish material 42 is preferably, although not exclusively, a UV protection gel coat. If desired, to better resemble an authentic painting, the varnish may be formed with an irregular surface such as by the application of brush strokes therein so that the surface of the varnish is irregular. It is also conceivable that depending on the type of fabric material used, the image 41′ can be laminated directly on that fabric material by heat. The burlap 34′ which extends over the outer surfaces 33 of the frame is painted a solid colour and that may also be covered with the varnish material 42. The hollow frame is preferably, but also not exclusively, a wooden frame of the type well known in the art for securing canvas.

It is within the ambit of the present invention to cover any obvious modifications of the preferred embodiment described herein, provided such modifications fall within the scope of the appended claims.

I claim:

1. A method of manufacturing a decorative plaque from a paper printed image, said method comprising the steps of:
i) embossing a canvas texture pattern in a sheet of paper having an image printed on a front face thereof,
ii) securing a rear face of said embossed paper sheet on a backing support member,
iii) applying a clear UV protective coating over said front face.

2. A method as claimed in claim 1 wherein said step (i) comprises feeding said sheet of paper in a roll embossing machine between an engraved roll having a canvas texture pattern engraved therein, and a backing roll.

3. A method as claimed in claim 1 wherein step (ii) comprises gluing said rear face of said embossed paper sheet to a flat backing rigid support member, and pressing said embossed paper sheet on said support member to remove excess glue.

4. A method as claimed in claim 1 wherein said step (iii) comprises applying one or more coats of varnish to said front face of said embossed paper sheet, and drying each said coat before applying an additional coat.

5. A method as claimed in claim 2 wherein said backing rigid support member is a thick, rigid backing member, and routing a decorative shape about outer edges of said thick rigid member.

6. A method as claimed in claim 2 wherein there is further provided the step (iv) of framing said decorative image plaque.

7. A decorative image plaque manufactured according to claim 1.

8. A decorative image plaque comprising a sheet of paper having an image printed on a front face thereof, said sheet of paper being embossed throughout with a canvas texture pattern, said sheet of paper having a rear face glued on a rigid flat backing support member, and a clear protective coating over said front face.

9. A decorative image plaque as claimed in claim 8 wherein said plaque has a contour decorative frame, said clear protective coating being a UV protective coating.

10. A decorative image plaque as claimed in claim 8 wherein said embossment simulates a canvas surface with bumps and valleys formed throughout said front and rear faces.

11. A composite print and frame comprising a circumferential hollow frame member having a flat outer contour surface, a sheet of fabric material disposed taut over said frame and secured to said flat outer contour surface, a printed image sheet has a rear surface thereof adhered over said sheet of fabric material, said image sheet extending to circumferential edges of said frame, said image sheet having an image on a top surface thereof, a protective transparent varnish material on said image sheet for protecting said image, fastening means for retaining said sheet of fabric material taut.

12. A composite print and frame as claimed in claim 11 wherein said frame has an open rear side with said sheet of a fabric material being visible and accessible between said hollow frames.

13. A composite print and frame as claimed in claim 11 wherein said varnish is a UV protection gel coat, said image sheet being a paper sheet.

14. A composite print and frame as claimed in claim 13 wherein said gel coat has a pattern formed therein to form an irregular surface to cause said image to resemble that of a painted image on said fabric material.

15. A composite print and frame as claimed in claim 11 wherein said fabric material is one of canvas, burlap, cheesecloth or other fabric material resembling canvas.

16. A composite print and frame as claimed in claim 11 wherein said printed image sheet is adhered over said fabric sheet by glue.

17. A composite print and frame as claimed in claim 11 wherein said printed image sheet is adhered over said fabric sheet by lamination.

18. A composite print and frame as claimed in claim 11 wherein said hollow frame is a rectangular wooden frame.

19. A composite print and frame as claimed in claim 11 wherein said fabric material extends over said flat outer contour surface and is painted with a solid color.

20. A composite print and frame as claimed in claim 19 wherein said varnish extends over said flat outer contour surface.

21. A composite print and frame as claimed in claim 11 wherein said fabric material extends over said flat outer contour surface and is secured by staple fasteners on rear surfaces of said hollow frame.

22. A composite print and frame as claimed in claim 14 wherein said irregular surface is comprised of brush strokes formed in said gel coat.
